(19) United States
(12) Patent Application Publication
(10) Pub. No.: US 2009/0001294 A1
(43) Pub. Date: Jan. 1, 2009

(54) Neutron Coincidence Counter for Non-Destructive Accounting for Nuclear Material and the Handling Thereof

(75) Inventors: Tae Hoon Lee, Daejeon (KR); Ho Dong Kim, Daejeon (KR); Won Il Ko, Daejeon (KR); Dae Yong Song, Cheonju-si (KR); Joong Hwan Jeong, Daejeon (KR); Sang Yoon Lee, Daejeon (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignees: KOREA ATOMIC ENERGY RESEARCH INSTITUTE, Daejeon (KR); KOREA HYDRO & NUCLEAR POWER CO., LTD., Seoul (KR)

(21) Appl. No.: 11/722,173

(22) PCT Filed: Sep. 29, 2006
(86) PCT No.: PCT/KR2006/003941

§ 371 Date: Nov. 9, 2007

(30) Foreign Application Priority Data
Oct. 7, 2005 (KR) 10-2005-0094583
Oct. 7, 2005 (KR) 10-2005-0094584

(51) Int. Cl. G21K 1/00

(52) U.S. Cl. 250/505.1

(57) ABSTRACT

A neutron coincidence counter for non-destructive accounting for a nuclear material according to the present invention comprises an outer case, neutron detectors mounted in the outer case while being surrounded by a moderator, and a basket horizontally movable in the outer case so as to be exposed outside the outer case and having a cavity for receiving a sample container therein. Further, a neutron coincidence counter for non-destructive accounting for a nuclear material according to the present invention comprises an outer case, neutron detectors mounted in the outer case while being surrounded by a moderator, a basket movable in the outer case so as to be exposed outside the outer case and having a cavity for receiving a sample container therein, and an external signal analyzer connected to the detectors through an electrically conductive path. Moreover, at least one facile connector of one-touch connection type is mounted on the electrically conductive path for connecting the detectors to the external signal analyzer, resulting in free removal and replacement of wires connected to the connector.

### TECHNICAL FIELD

The present invention relates to a neutron coincidence counter for non-destructive accounting for a nuclear material and a handling method thereof, and more particularly, to a neutron coincidence counter for non-destructive accounting for a nuclear material, which is suitable for non-destructive accounting and inspection for a nuclear material in a high-level radioactive environment, and a handling method thereof.

### BACKGROUND ART

An operation for handling a high-level radioactive material or nuclear material, such as a reprocessing operation for nuclear fuel used in a light water reactor, produces an environment in which there exists a lot of radiation such as high-level gamma radiation emitted from the nuclear material. However, an operation may be performed in such an environment so as to achieve a practical objective such as nuclear fuel reprocessing. In order to perform such an operation, for example, to perform an operation in a hot cell, that is a high-level radioactive material handling facility, there is a need for an operating apparatus and an accounting and inspection apparatus, which can be remotely controlled.

As an apparatus for performing such an accounting process, a well-type neutron coincidence counter for accounting of a high-level radioactive nuclear material is disclosed in Korean Patent Application No. 10-1998-0009907 filed in the name of the Korea Atomic Energy Research Institute and the Korea Electric Power Corporation.

In this neutron coincidence counter, a sample-conveying container, which has a high-level radioactive material sample contained therein and is inserted into an inner decontamination vessel, is positioned at a radioactive source position where the sample should be positioned, and neutron reflectors are positioned above and below the sample. A shield body guard plate and a gamma radiation shield body are mounted outside the decontamination vessel, and a plurality of detection tubes with cadmium plates partially attached thereto are mounted outside the shield body. The plurality of detection tubes are surrounded by a neutron moderator while they are connected to preamplifiers positioned to upper ends thereof. All of these components are surrounded by a main body case and supported by a main body support. Various kinds of connectors and status check lamps are mounted outside the main body case.

Further, an inner gas mixture contained in each detection tube comprises a material capable of easily separating a neutron signal, which is inputted together with a gamma radiation signal, from the gamma radiation signal, and the preamplifier with the detection tube connected thereto comprises electronic components made of a radiation resistant material.

However, as expected from the term “well-type” included in the name of such a conventional counter, a sample-mounting portion is installed such that a sample can be attached or detached in a vertical direction. Since only an inlet portion through which the sample is attached or detached is visible from the outside in such a configuration, there is a problem in that it is difficult for an operator to exactly recognize an operational state with the naked eye. Accordingly, there are problems in that it is generally difficult to attach or detach the sample by means of a remote controller, and operational danger such as dropout of the sample may increase due to an incorrect operation or a misunderstanding of a situation in the conventional counter.

That is, since the detection tubes, the preamplifiers with the detection tubes connected thereto, signal lines or power lines, and the status of these connection terminals in which some problems may occur in the conventional neutron coincidence counter cannot be viewed well, the counter has difficulty in maintaining, managing and operating these components.

Further, since such a neutron coincidence counter exists together with a high-level radioactive material in a space in which the high-level radioactive material is handled, it is very difficult and troublesome to withdraw the counter from the space or to newly insert the counter into the space. Accordingly, the conventional counter requires very high reliability and durability. However, some problems may occur in the counter. In this case, it is necessary to operate the counter in the same space in order to solve these problems. To facilitate such an operation by using the remote controller, the operation should be performed more stably.

In this regard, the conventional neutron coincidence counter with such a vertical structure has problems with maintenance of the counter in view of a filed of view and operational safety. In addition, since the gamma radiation shield body and the neutron moderator are integrally formed, a problem that may occur in the components cannot be easily solved, leading to difficulty in performing general installation, replacement and repair operations.

### DISCLOSURE OF INVENTION

### Technical Problem

The present invention is conceived to solve the aforementioned problems in the prior art. Accordingly, an object of the present invention is to ensure that typical operations such as loading or unloading of a nuclear material sample into or from a neutron coincidence counter for accounting and inspection of a nuclear material can be more conveniently and stably performed as compared with a conventional vertically mounted type neutron coincidence counter.

Furthermore, another object of the present invention is to facilitate maintenance of a neutron coincidence counter through a more convenient wiring connection structure as compared with a conventional neutron coincidence counter, so that only some of connections in a wiring system between a plurality of detectors and an external signal analyzer can be separated or re-connected even with only an operation performed by a remote controller.

### Technical Solution

According to an aspect of the present invention for achieving the objects, there is provided a neutron coincidence counter for non-destructive accounting for a nuclear material, comprising an outer case, neutron detectors mounted in the outer case while being surrounded by a moderator, and a basket horizontally movable in the outer case so as to be exposed outside the outer case and having a cavity for receiving a sample therein.

According to another aspect of the present invention for achieving the objects, there is provided a neutron coincidence counter for non-destructive accounting for a nuclear material, comprising an outer case, neutron detectors mounted in the outer case while being surrounded by a moderator, a basket movable in the outer case so as to be at least partially exposed outside the outer case and having a cavity for receiving a sample therein, and an external signal analyzer connected to the detectors through an electrically conductive path, wherein at least one facile connector of one-touch connection type is mounted on the electrically conductive path for connecting the detectors positioned in an inner space of the outer case to the external signal analyzer.

In a method of handling a neutron coincidence counter for non-destructive accounting for a nuclear material according to the present invention, the nuclear material is loaded into an outer case of the neutron coincidence counter, and neutrons emitted from the nuclear material are accounted by using a plurality of neutron detectors mounted around the mounted position of the nuclear material. The method comprises the steps of horizontally moving a basket, which is mounted in the outer case and formed with a cavity as a space for loading the nuclear material therein, in one direction so that the basket can be at least partially withdrawn from the outer case; seating the nuclear material in the cavity by using a remote control device; and horizontally moving the basket in a direction opposite to the one direction so that the basket can be contained in the outer case, and performing an accounting process for the nuclear material by the neutron detectors mounted in the outer case.

### ADVANTAGEOUS EFFECTS

According to the present invention, typical operations such as loading or unloading of a nuclear material sample into or from a neutron coincidence counter for accounting and inspection of a nuclear material can be more conveniently and stably performed as compared with a conventional vertically mounted type neutron coincidence counter.

Further, since an operator can perform maintenance of the neutron coincidence counter while directly viewing an electronic box, preamplifiers and detection tubes, which are most essential to the maintenance, the maintenance can be performed, more particularly, in a convenient and stable manner.

Moreover, since the neutron coincidence counter for non-destructive accounting for a nuclear material according to the present invention has a simpler wire connection structure as compared with a conventional neutron coincidence counter, only some of connections in a wiring system between a plurality of detectors and an external signal analyzer can be sufficiently separated or re-connected as required for maintenance even with only an operation performed by a remote controller, thereby facilitating the maintenance of the neutron coincidence counter.

According to the present invention, since large-sized and heavy-weighted components such as a shield body and a moderator in the neutron coincidence counter of the present invention are modularized, it can be easy to mount or demount the neutron coincidence counter in or from a high-level radioactive region such as a hot cell.

### BRIEF DESCRIPTION OF THE DRAWINGS

FIG. 1 is schematic, partially cut-away perspective view in a first embodiment of the present invention.

FIG. 2 is a schematic, sectional side view in the first embodiment of the present invention.

FIG. 3 is a view illustrating an operational concept of an operation for taking-in or taking-out a nuclear material in the first embodiment of the present invention.

FIGS. 4 and 5 are a front view and a horizontal sectional view in a state where a hatch is opened in a second embodiment of the present invention, respectively.

FIGS. 6 and 7 are sectional side views showing states where a basket is contained and taken out in and from an outer case of a neutron coincidence counter in a third embodiment of the present invention, respectively.

FIG. 8 is a schematic wiring diagram mainly showing wiring connections of preamplifiers, signal lines and power lines in the neutron coincidence counter according to the present invention.

FIGS. 9 and 10 are a perspective view and a detailed view showing a connection state of a coupling box and the preamplifiers in the neutron coincidence counter according to the present invention, respectively.

### EXPLANATION OF REFERENCE NUMERALS FOR MAIN PORTIONS IN DRAWINGS

10: Detection tube 20, 21: Moderator
30: Shield body 31, 33, 35: Shield
40: Preamplifier 50: Cavity
60: Graphite reflector 70: Nickel reflector
80: Cadmium moderator 90: Basket
91: Knob 94, 92: Roller
100: Coupling box 110: Facile connector
115: LED device 120: LED box
130: Outer case 200, 210: Sample
310: Robot arm 320: Hook

### BEST MODE FOR CARRYING OUT THE INVENTION

Hereinafter, the present invention will be described in detail in connection with embodiments with reference to the accompanying drawings.

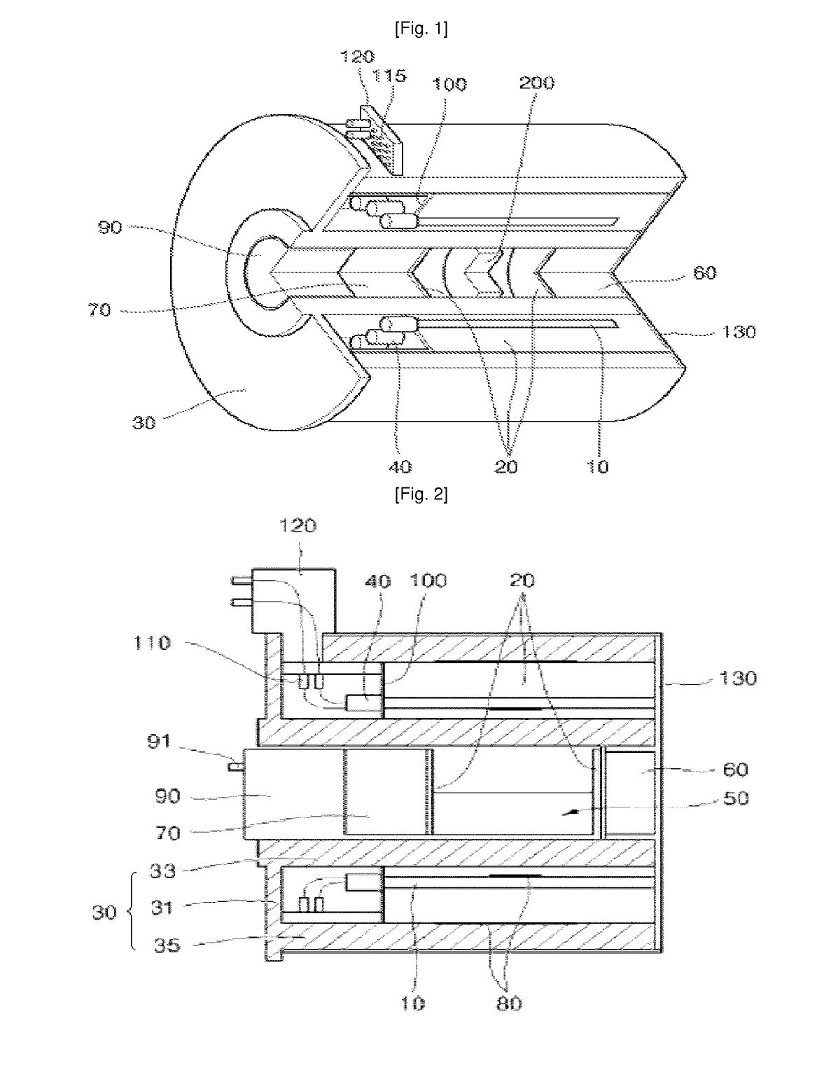

FIGS. 1 and 2 are a schematic, partially cut-away perspective view and a schematic, sectional side view in a first embodiment of the present invention, respectively.

According to the first embodiment of the present invention, as shown in FIGS. 1 and 2, an outer case 130 taking the shape of a cylinder with a closed end and made of stainless steel is installed such that an open portion of the outer case 130 is in a horizontal state. That is, the outer case 130 is in the form of a cylindrical container and is installed such that a central axis of the cylinder is positioned in a horizontal plane. A support (not shown) may be provided at a lower portion of the outer case 130 so that an apparatus can be stably installed.

A shield body 30 is mounted inside the outer case 130. If necessary, an outermost shield body may serve as the outer case 130. The shield body 30 comprises a first shield 35 mounted in a cylindrical shape adjacent to the outer case 130, a second shield 33 mounted in a cylindrical shape and spaced apart by a predetermined distance from the first shield 35 so as to be relatively closer to a central side, and a third shield 31 that is contiguous to the first and second shields 35 and 33 at one sides of the first and second shields 35 and 33, i.e., at an opening side end of the outer case 130, and covers a substantial part of the open portion of the outer case 130 radially outward from the central axis.

Although the shield body is typically made of a lead plate capable of shielding gamma radiation, other shielding metals or alloys having a relatively lighter weight may be used, if necessary. The first shield 35 prevents the gamma radiation from entering a detector so that it can allow detection tubes 10 to exactly detect neutrons. The outer, first shield 35 and the third shield 31 function to prevent the detection tubes 10 from being affected by the gamma radiation emitted from an external nuclear material, and to alleviate the effects of radiation on preamplifiers 40 or electric or electronic components positioned at one ends of the detection tubes 10.

A basket 90 is mounted inside the cylinder defined by the second shield 33. The basket 90 is in the form of a kind of cylinder having partitions and made of stainless steel. A cavity 50 in which a sample is to be received is positioned in a middle portion of the basket 90. Neutron reflectors may be mounted at front and rear sides of the cavity 50. As for the reflectors, a nickel reflector 70 is positioned at the opening side of the outer case and a graphite reflector 60 is positioned at the closed end side of the outer case. The basket is formed such that an upper cylinder wall or cover is not formed in the cavity 50, i.e., an upper portion of the cavity 50 is open, whereby a sample ingot or a container with a sample contained therein can be conveniently received in and taken out from the cavity 50 through the upper portion of the cavity. In this embodiment, the basket 90 is constructed to have a space with the nickel reflector 70 mounted therein and the space of the cavity 50, and the graphite reflector 60 is mounted at the closed face of the outer case 130 so as to be contiguous to the space of the cavity 50. The basket 90 may be provided with a knob 91, a protrusion or a ring on the side of the opening portion of the outer case 130, so that a remotely controlled robot arm can easily grasp the knob or the like.

The reflectors may be made of graphite and nickel having superior neutron moderation and reflection efficiencies so that neutrons, which are not directed to the detectors among neutrons emitted from a sample 200, can approach the detectors more and more through reflection and then be detected. The reflectors may be mounted using a stainless steel casing when it is mounted at the basket 90 or at the closed face of the outer case 130.

A plurality of detectors are mounted around the outside of the second shield 33 while annularly surrounding the basket 90 positioned on the central axis of the outer case 130 and the second shield 33. The remainder of the space between the first shield 35 and the second shield 33 is filled with a neutron moderator 20 except a certain region of the space on the side of the opening portion of the outer case 130. Accordingly, the detectors are surrounded by the moderator 20. At this time, the moderator serves to moderate neutrons with high speed, which are emitted from the nuclear sample, to be changed into thermal neutrons with low speed, which in turn may react with a detection material in the detectors with a higher possibility. A material such as high density polyethylene which comprises a material having a higher hydrogen density per volume may be used as the moderator 20. The moderator 20 may also be mounted to a surface of the nickel reflector or graphite reflector, which faces the sample.

An interior medium for detecting the neutrons, which is used in the detector, comprises a material that can easily separate a neutron signal, which is inputted together with a gamma radiation signal, from the gamma radiation signal by differentiating the signals from each other. The preamplifier 40 connected to each of the detectors comprises electronic components made of a radiation resistant material. The detector includes the detection tube 10 that contains He gas generally having a mass number of 3 under a pressure of several bars, and the detection tube 10 may be formed of a thin aluminum tube with both sealed sides. The detection medium such as He generates charged particles through reaction with the neutrons, the charged particles are captured by the detector to generate a current signal, and the current signal is changed into a voltage signal to be transmitted to an external signal analyzer. Herein, the preamplifier 40 is mounted to the detection tube 10 on the side of the opening portion of the outer case 130. The preamplifier 40 can perform signal conversion, signal amplification and the like, and is typically connected to an external power supply and a signal line.

Although the preamplifier 40 is generally formed of radiation resistant components, many of these components may be difficult to withstand a high-level radiation environment for a long time and thus may be required to be replaced with new ones. Further, the detection tube 10 may also be required to be replaced with a new one on the grounds that the sealed state of the detection tube 10 is not maintained. In this case, one end of the detection tube 10 and a portion of the preamplifier 40 connected thereto are formed into a plug and a holder, respectively, and a predetermined number of electrical connection terminals with proper dimensions are formed at appropriate positions inside the holder. Such a holder configuration is used in combination with a facile connector. When such a simple insertion structure in which there is no thread on contact surfaces of the plug and the holder is employed, attachment and detachment between the detection tube 10 and the preamplifier 40 can be easily achieved only with a small force. Accordingly, in such a structure, a robot arm controlled by a remote controller can be used to facilitate the electrical connection and the physical attachment/detachment between the detection tube 10 and the preamplifier 40.

Cadmium moderators 80 can be partially attached to a central portion of the detection tube 10 in a longitudinal direction (the direction of the central axis of the outer case) and a central portion of the outer shield body, thereby improving uniformity of detection of neutrons in the longitudinal direction.

An aluminum coupling box 100 is mounted in an empty region on the side of the opening portion of the outer case 130 in the space between the first shield 35 and the second shield 33. The coupling box 100 can function, together with the moderator 20, to designate the positions of the detection tube 10 and the preamplifier 40.

Signal lines and power lines are drawn outside of the outer case 130 from the preamplifier 40 through the coupling box 100. A light emitting diode (LED) box 120 is mounted outside the outer case. A plurality of LED devices 115 to be connected to the detection tubes 10 through the signal lines are installed in the LED box 120. Thus, the LED devices 115 can emit light so that the detection of neutrons by the detector can be recognized from the outside. Connection terminals of the LED box 120 and the coupling box 100 serve as intermediate connection points between the external power supply and the signal lines.

A cable including wires led out from the preamplifier 40 is in the form of Type 1 plug having multi-stage electrodes at the other end. One side of the coupling box 100 is formed with Type 1 facile connectors 110 of which the number corresponds to the number of the detection tubes 10. A connection terminal corresponding to each signal line (lead wire) in Type 1 facile connector 110 is formed to have an inner stepped portion that conforms to the shape of a corresponding plug. Insulation is provided to prevent the connection terminals from being crossed. A cable including a plurality of wires of which the number corresponds to the number of signal lines or power lines is led out from Type 1 facile connector 110, passes through the outer case 130 of the neutron coincident counter, and is then connected to the LED box 120 mounted outside the outer case 130. Other facile connectors are also formed at the LED box 120 so that the LED box can be connected to terminals of the external power supply and the external signal analyzer by means of plugs and cables connected to the facile connectors.

Consequently, some simple insertion type facile connectors and the plugs and the cables connected thereto enable the signal terminals and the power terminals of the preamplifier 40 to be connected to the signal analyzer and the power supply that are placed outside the neutron coincidence counter. The LED box 120 is provided with a plurality of LED devices 115 which are connected to the detection tubes 10 through the signal lines. Thus, the LED devices 115 emit light so that the detection of neutrons by the detectors can be recognized from the outside. The facile connectors of the LED box 120 or the coupling box 100 serve as the intermediate connection points of the external power supply and the signal lines so that the facile connectors may be connected to or disconnected from the plugs by means of a remote controller (not shown), if necessary.

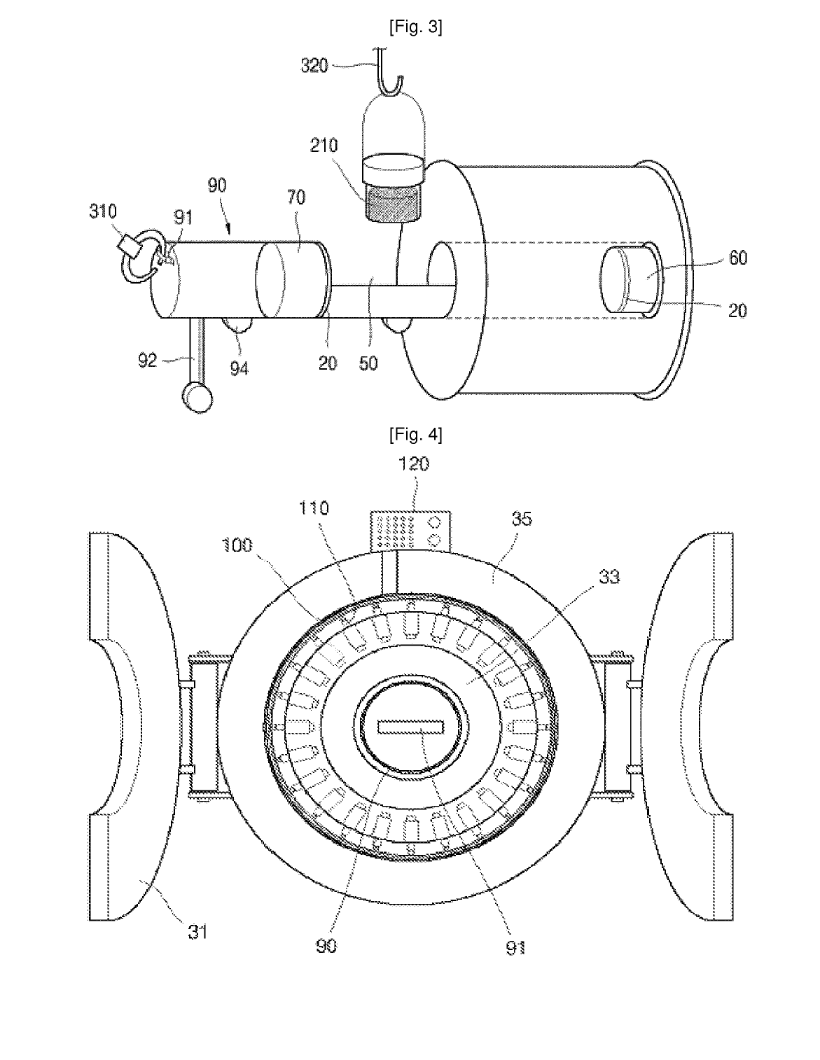

FIG. 3 is a view illustrating an operational concept of an operation for taking-in or taking-out a nuclear material in the first embodiment of the present invention.

Referring to FIG. 3, there is shown an embodiment in which a support roller 92 brought into contact with an installation floor for the neutron coincidence counter is mounted to the basket 90 on the side of an end of the opening portion of the outer case, and the knob 91 or a ring is attached to the basket 90.

A roller 94 may be mounted on a portion of a lower surface of the basket 90 that comes into contact with an inner surface of the shield body surrounding the basket 90. The rollers 92 and 94 allow a horizontal movement of the basket 90 to be performed easily and smoothly as compared with a simple sliding movement of the basket 90. Accordingly, a remotely controlled robot arm 310 in a hot cell that has relatively lower power may assist the horizontal movement operation of the basket 90. Although not shown, protrusions may be formed respectively at an end of the basket 90 on the side of the cavity 50 and at an end of the shield body with which the basket 90 comes into contact on the side of the end of the opening portion of the case, so that the protrusions are caught by each other. Accordingly, even though the basket 90 is withdrawn maximally outside the outer case 130, the basket 90 can be prevented from being completely separated from the outer case 130 (more specifically, from a cylindrical surface of the second shield shown in FIG. 1).

The basket 90 can be made of stainless steel. The portion of the basket defining the space in which the nickel reflector 70 is mounted may also be integrally formed of stainless steel, and the portion defining the space in which the graphite reflector 60 is mounted may also be formed of the same material as the stainless outer case 130.

The cylindrical wall defining the basket 90 is partially removed at the upper side of the cavity 50, so that a sample container depending from a crane hook 320 in the hot cell can be directly loaded into the basket when the basket 90 is withdrawn from the outer case 130 of the neutron coincidence counter. A nuclear material sample 210 having a high level of radioactivity may be loaded into the cavity while being contained in a container, or may be loaded in the form of an ingot directly into the cavity 50.

Accordingly, when the remote controller causes the robot arm 310 to grasp and horizontally pull the knob 91 or ring of the basket 90 on the side of the opening portion of the outer case in accordance with the method of the present invention, the basket 90 is moved outward from the outer case in a state where the basket 90 has been mounted within the neutron coincidence counter, thereby exposing the cavity. The container in which the sample 210 previously prepared has been contained is loaded into the cavity 50 by means of the hook 320 of the crane which is remotely controlled. Then, the robot arm 310 horizontally moves the basket 90 in a reverse direction so that it can be pushed back into the outer case of the neutron coincidence counter. Of course, when a sample that has been completely subjected to an accounting process is intended to be taken out from the neutron coincidence counter, the sequence of the aforementioned processes should be reversed.

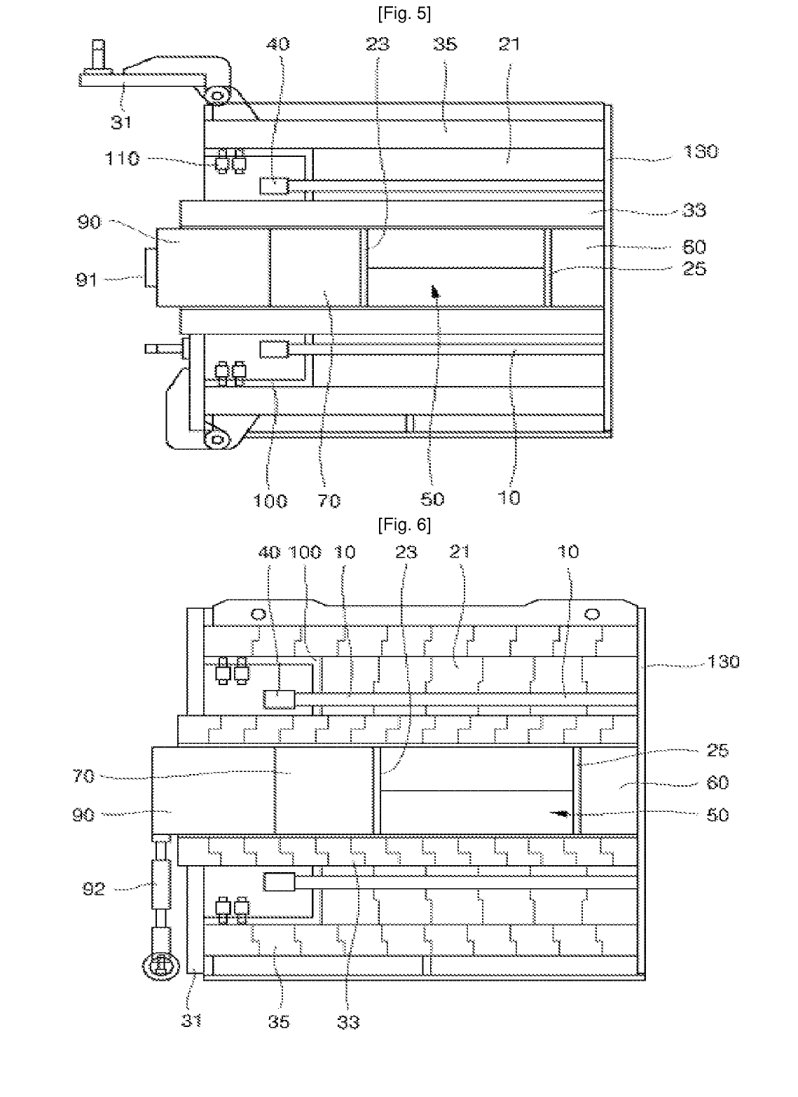

FIGS. 4 and 5 are a front view and a horizontal sectional view in a state where a hatch is opened in a second embodiment of the present invention, respectively. That is, FIGS. 4 and 5 show that the third shield 31 of FIGS. 1 and 2 is replaced with a hatch-type third shield 31 which can be opened or closed. Accordingly, the third shield 31 in the second embodiment of the present invention is brought into contact with the first and second shields 35 and 33 but is not formed integrally and continuously with the first and second shields 35 and 33. Such a hatch-type design provides convenience superior to a conventional one in view of maintenance of the neutron coincidence counter in the hot cell. That is, when an operator that uses or repairs the neutron coincidence counter opens the hatch-type third shield 31, he/she can perform an operation while directly viewing and checking the coupling box 100 positioned therein, the preamplifiers 40 mounted to be partially fixed to the coupling box 100 and the upper ends of the detection tubes 10.

Furthermore, when the operator that uses or repairs the neutron coincidence counter opens the hatch-type third shield 31, he/she can perform an operation while directly viewing and checking the coupling box 100 positioned therein and the upper ends (not shown) of the detection tubes 10 connected to the preamplifiers 40 that have wire cables (not shown) connected to Type 1 facile connectors 110 provided at the coupling box 100 and are disposed at predetermined positions on the coupling box.

That is, if it is required to replace a detection tube 10 disposed at a certain position with a new one, the hatch-type third shield 31 is first opened. Then, the remote controller (not shown) is used to pull a preamplifier 40, which has been connected to the corresponding detection tube 10, viewed from the outside when the hatch-type shield 31 is opened, so that the preamplifier can be separated from the detection tube 10. Subsequently, the remote controller is used to pull an exposed end of the detection tube 10 so that the detection tube 10 can be taken out between the coupling box 100 and the moderator 21. A new detection tube 10 to be replaced for the used detection tube is mounted between the coupling box 100 and the moderator 21 by performing the sequence of the aforementioned processes in a reverse order of the operation for taking out the used detection tube 10. The remote controller is used to connect the preamplifier 40 to an exposed end of the newly mounted detection tube 10. When the aforementioned operations are completed, the hatch-type third shield 31 is closed.

In this embodiment, the hatch is constructed to be divided into two side parts so that the parts can be opened from the center toward both lateral sides. However, it may be constructed into a single part to be opened toward one lateral side.

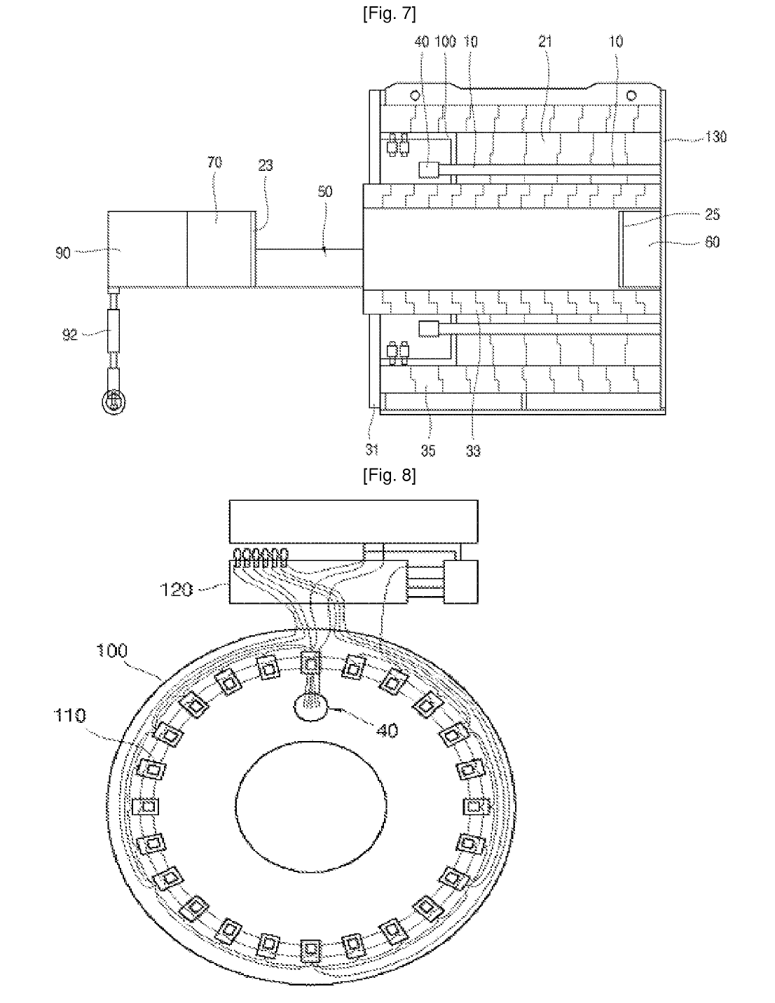

FIGS. 6 and 7 are sectional side views showing states where a basket is contained and taken out in and from an outer case of a neutron coincidence counter in a third embodiment of the present invention, respectively.

Referring to FIGS. 6 and 7, similarly to the embodiment shown in FIG. 3, the roller 92 is mounted at the end of the basket 90 on the side of the opening portion of the outer case. Accordingly, the basket 90 can be withdrawn easily with a small force when the remotely controlled robot arm is actuated to withdraw the basket 90. Meanwhile, in this embodiment, the moderator 21 and the first and second shields 35 and 33 of the shield body are divided into a plurality of pieces in a modularized structure. Since a metal such as Pb that is widely used as the shield body has heavy weight, it may be difficult to perform an operation if the shield body in the present invention is made as a unitary part. Accordingly, the modularized structure of the embodiment of the present invention facilitates operations for mounting or demounting the neutron coincidence counter in or from the hot cell.

Although the shields 33 and 35 or the moderator 21 comprises a plurality of pieces which are axially fitted to one another in this embodiment, they may also comprise a plurality of pieces which are divided in other configurations.

A method of loading or unloading the sample into or from the basket 90 using the embodiment constructed as above will be described. The roller 92 causes the horizontal movement of the basket 90 to be easily and smoothly performed as compared with a simple sliding movement of the basket 90. Accordingly, the remotely controlled robot arm in the hot cell that has relatively lower power may assist the horizontal movement operation of the basket 90. Although not shown, protrusions may be formed respectively at an end of the basket 90 on the side of the cavity 50 and at an end of the shield body with which the basket 90 comes into contact on the side of the end of the opening portion of the case, so that the protrusions are caught by each other. Accordingly, even though the basket 90 is withdrawn maximally outside the outer case 130, the basket 90 can be prevented from being completely separated from the outer case 130 (more specifically, from a cylindrical surface of the second shield 33).

The basket 90 can be made of stainless steel. The portion of the basket defining the space in which the nickel reflector 70 is mounted may also be integrally formed of stainless steel, and the portion defining the space in which the graphite reflector 60 is mounted may also be formed of the same material as the stainless outer case 130.

The cylindrical wall defining the basket 90 is partially removed at the upper side of the cavity 50, so that a sample container depending from a crane hook in the hot cell can be directly loaded into the basket when the basket 90 is withdrawn from the outer case 130 of the neutron coincidence counter. A nuclear material sample having a high level of radioactivity may be loaded into the cavity while being contained in a container, or may be loaded in the form of an ingot directly into the cavity 50.

Accordingly, when the remote controller causes the robot arm to grasp and horizontally pull the knob or ring of the basket on the side of the opening portion of the outer case in accordance with the neutron accounting method of this embodiment of the present invention, the basket 90 is moved outward from the outer case in a state where the basket has been mounted within the neutron coincidence counter, thereby exposing the cavity. The container in which the sample previously prepared has been contained is loaded into the cavity by means of the hook of the crane which is remotely controlled. Then, the robot arm horizontally moves the basket 90 in a reverse direction so that it can be pushed back into the outer case of the neutron coincidence counter. Of course, when a sample that has been completely subjected to an accounting process is intended to be taken out from the neutron coincidence counter, the sequence of the aforementioned processes should be reversed.

FIG. 8 is a schematic wiring diagram mainly showing wiring connections of preamplifiers, signal lines and power lines in the neutron coincidence counter according to the present invention.

Referring to FIG. 8, a TTL pulse-shaped output may be generated per one reaction neutron in the detection tube 10. When an LED positioned on the external LED box 120 is turned on simultaneously with the generation of the output, it is possible to recognize the detection of a neutron and a response status in the detection tube 10.

The preamplifiers 40 may be classified into several groups so as to diagnose whether a preamplifier 40 itself and a connection line for connection to the outside are abnormal. Here, although only one preamplifier 40 is shown in the figure, it will be apparent that a plurality of preamplifiers 40 corresponding to connection terminals are mounted. In this embodiment, for example, several connection terminals adjacent to one another are grouped as shown in the figure. Similarly, every five or six of the plurality of preamplifiers 40 are grouped, and the values of output signals from the separate signal lines are compared with one another to recognize whether the signal lines are normal. If there is abnormality in a preamplifier 40, an LED connected to the corresponding preamplifier 40 in the LED box 120 is turned off or emits weak light. Meanwhile, if there is abnormality in the lines for connecting preamplifiers 40 in a group or the connection terminals, the value of an output signal, i.e., detection intensity, different from a normal value may be represented.

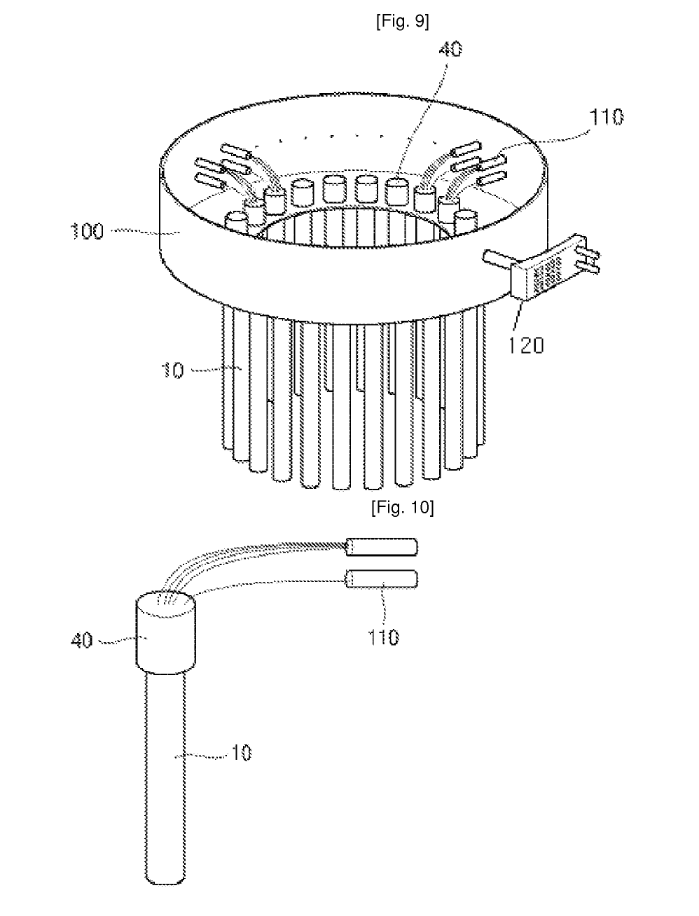

FIGS. 9 and 10 are a perspective view and a detailed view showing the connection state of the coupling box and the preamplifiers in the neutron coincidence counter according to the present invention, respectively.

The preamplifier 40 with one end thereof connected to the detection tube 10 is connected to a plurality of wires at the other end thereof. The respective wires may be divided into a high voltage line and a cable comprising different signal lines such as TTL OUT, TTL IN, LED and 5-volt line. Both the high voltage line and the cable are connected to the facile connectors 110 of the coupling box 100. The facile connectors 110 are connected to corresponding facile connectors of the LED box 120 positioned outside the outer case, and the facile connectors of the LED box 120 are connected to terminals of an external power supply or an external apparatus.

A bundle of a plurality of wires may be formed into a kind of cable of which a distal end is in the form of a multi-terminal multi-stage plug. The plug may be connected to a facile connecter having complementary multiple connection terminals.

The aforementioned embodiments have been disclosed in order to describe the basic or other additional features of the present invention. It will be apparent that the present invention is not limited to these embodiments, and the present invention can be implemented by a variety of combinations of these features.

### INDUSTRIAL APPLICABILITY

According to the present invention, there is provided a horizontally-structured neutron coincidence counter for non-destructive accounting for a nuclear material, wherein typical operations such as loading or unloading of a nuclear material sample into or from a neutron coincidence counter for accounting and inspection of a nuclear material can be more conveniently and stably performed as compared with a conventional vertically mounted type neutron coincidence counter.

Further, according to the present invention, since an operator can perform maintenance of the neutron coincidence counter while directly viewing an electronic box, preamplifiers and detection tubes, which are most essential to the maintenance, the maintenance can be performed, more particularly, in a convenient and stable manner.

Moreover, according to the present invention, there is provided a remotely controllable neutron coincidence counter for non-destructive accounting for a nuclear material, wherein only some of connections in a wiring system between a plurality of detectors and an external signal analyzer can be sufficiently separated or re-connected as required for maintenance even with only an operation performed by a remote controller, thereby facilitating the maintenance of the neutron coincidence counter.

In addition, since large-sized and heavy-weighted components such as a shield body and a moderator in the neutron coincidence counter of the present invention are modularized, it can be easy to mount or demount the neutron coincidence counter in or from a high-level radioactive region such as a hot cell.

1. A neutron coincidence counter for non-destructive accounting for a nuclear material, comprising:
an outer case (130);
neutron detectors (10) mounted in the outer case (130) while being surrounded by a moderator (20); and
a basket (90) horizontally movable in the outer case (130) so as to be exposed outside the outer case (130) and having a cavity (50) for receiving a sample therein.

2. The non-destructive neutron coincidence counter as claimed in claim 1, wherein rollers (92, 94) for the horizontal movement of the basket (90) are mounted at one or more positions on the basket (90).

3. The non-destructive neutron coincidence counter as claimed in claim 1, wherein at least some portion of the upper side of the cavity (50) of the basket (90) is open upwardly so that the sample can have free access to the cavity (50).

4. The non-destructive neutron coincidence counter as claimed in claim 1, wherein a hatch for opening a portion of the outer case (130) is mounted such that at least a portion of the interior of the outer case (130) can be opened in a horizontal direction.

5. The non-destructive neutron coincidence counter as claimed in claim 4, wherein a radiation shield body (33, 35) is mounted outside the cavity (50) and within an inner space of the outer case (130) including the outer case (130) itself, and at least one of the moderator (20) and the radiation shield body (33, 35) comprises a plurality of modular components separately mounted along a horizontal direction in which a face to be opened by the hatch is directed.

6. The non-destructive neutron coincidence counter as claimed in claim 1, wherein the outer case (130) takes the shape of a cylindrical container with an open side and is installed such that a central axis of the cylinder is positioned in a horizontal plane,
the shield body (30) formed inside the outer case (130) and outside the cavity (50) comprises a first shield (35) in the form of a cylinder mounted near to the outer case (130), a second shield (33) in the form of a cylinder mounted while being spaced apart by a predetermined distance from the first shield (35), and a hatch-type shield (31) mounted to be in contact with one side ends of the first and second shields (35, 33) and to be openable from the one side ends so as to open the interior of the outer case,
the basket (90) is axially mounted along the center of the outer case (130) inside the second shield (33),
the detectors (10) are mounted in a space between the first and second shields (35, 33) and surrounded by the neutron moderator (20) except a predetermined region of the space near the open side,
the detectors (10) comprise a plurality of detection tubes mounted horizontally and lengthwise in parallel with the mounted direction of the basket (90) along a periphery of the basket (90), each of the detection tubes having closed both ends and containing He gas with a mass number of 3 therein, and
in a space of the predetermined region is provided a coupling box (100) connected to the one side ends of the detectors (10), the coupling box containing wires and electric/electronic components for processing neutron signals detected by the detectors (10) to be transmitted to the outside.

7. The non-destructive neutron coincidence counter as claimed in claim 6, wherein at least one among the moderator (20), the first shield (35) and the second shield (33) comprises a plurality of modular components separately mounted along an axial direction of the outer case (130).

8. A neutron coincidence counter for non-destructive accounting for a nuclear material, comprising:
an outer case (130);
neutron detectors (10) mounted in the outer case (130) while being surrounded by a moderator (20);
a basket (90) movable in the outer case (130) so as to be at least partially exposed outside the outer case (130) and having a cavity (50) for receiving a sample therein; and
an external signal analyzer connected to the detectors (10) through an electrically conductive path,
wherein at least one facile connector (110) of one-touch connection type is mounted on the electrically conductive path for connecting the detectors (10) positioned in an inner space of the outer case (130) to the external signal analyzer.

9. The non-destructive neutron coincidence counter as claimed in claim 8, wherein the basket (90) is mounted such that the cavity (50) can be exposed outside the outer case (130) through a horizontal movement of the basket in the outer case (130).

10. The non-destructive neutron coincidence counter as claimed in claim 9, wherein rollers (92, 94) for the horizontal movement of the basket (90) are mounted at one or more positions on the basket (90).

11. The non-destructive neutron coincidence counter as claimed in claim 9, wherein at least an upper side of the cavity (50) of the basket (90) is open upwardly so that the sample can have free access to the cavity (50).

12. The non-destructive neutron coincidence counter as claimed in claim 8, wherein a hatch for opening a portion of the outer case (130) is mounted so that the facile connector (110) positioned in the outer case (130) can be exposed.

13. The non-destructive neutron coincidence counter as claimed in claim 12, wherein a radiation shield body (33, 35) is mounted outside the cavity (50) and within an inner space of the outer case (130) including the outer case (130) itself, and at least one of the moderator (20) and the radiation shield body (33, 35) comprises a plurality of modular components separately mounted along a direction in which a face to be opened by the hatch is directed.

14. The non-destructive neutron coincidence counter as claimed in claim 8, wherein the outer case (130) takes the shape of a cylindrical container with an open side and is installed such that a central axis of the cylinder is positioned in a horizontal plane,
the shield body (30) formed inside the outer case (130) and outside the cavity (50) comprises a first shield (35) in the form of a cylinder mounted near to the outer case (130), a second shield (33) in the form of a cylinder mounted while being spaced apart by a predetermined distance from the first shield (35), and a hatch-type shield (31) mounted to be in contact with one side ends of the first and second shields (35, 33) and to be openable from the one side ends so as to open the interior of the outer case,
the basket (90) is axially mounted along the center of the outer case (130) inside the second shield (33),
the detectors (10) are mounted in a space between the first and second shields (35, 33) and surrounded by the neutron moderator (20) except a predetermined region of the space near the open side,
the detectors (10) comprise a plurality of detection tubes mounted horizontally and lengthwise in parallel with the mounted direction of the basket (90) along a periphery of the basket (90), each of the detection tubes having closed both ends and containing a neutron detection gas therein, and
in a space of the predetermined region are provided a coupling box (10) and preamplifiers (40) connected to the one side ends of the detectors (10) so as to process neutron signals detected by the detectors (10) to be transmitted to the external signal analyzer, the coupling box and the preamplifiers being installed as a part of the electrically conductive path, the facile connector (110) being mounted in the coupling box (100) and connected to the preamplifiers (40).

15. The non-destructive neutron coincidence counter as claimed in claim 14, wherein one end of each of the detectors 10 is in the form of a plug to be inserted into one of the preamplifiers 40 so that one-touch attachment and detachment can be achieved therebetween.

16. A method of handling a neutron coincidence counter for non-destructive accounting for a nuclear material, wherein the nuclear material is loaded into an outer case, and neutrons emitted from the nuclear material are accounted by using a plurality of neutron detectors mounted around the mounted position of the nuclear material, comprising the steps of:
horizontally moving a basket mounted in the outer case in one direction so that the basket can be at least partially withdrawn from the outer case, the basket being formed with a cavity as a space for loading the nuclear material therein;
seating the nuclear material in the cavity by using a remote control device; and
horizontally moving the basket in a direction opposite to the one direction so that the basket can be contained in the outer case, and performing an accounting process for the nuclear material by the neutron detectors mounted in the outer case.
